(19) United States
(12) Patent Application Publication
(10) Pub. No.: US 2015/0160374 A1
(43) Pub. Date: Jun. 11, 2015

(54) WEATHER INFORMATION SIGNAL PROCESSING MODULE

(71) Applicant: WEATHERLINK CO., LTD, Seongnam-si, Gyeonggi-do (KR)

(72) Inventor: Jeongho Choi, Uijeongbu-si (KR)

(21) Appl. No.: 14/411,570

(22) PCT Filed: Apr. 8, 2014
(86) PCT No.: PCT/KR2014/003027

§ 371 Date: Dec. 29, 2014

(30) Foreign Application Priority Data
Apr. 18, 2013 (KR) 10-2013-0043045

(51) Int. Cl. G01W 1/10

(52) U.S. Cl. CPC G01W 1/10

(57) ABSTRACT

Disclosed is a weather information signal processing module comprising: an operation processing unit for pulse-compressing a weather signal received from the outside, calculating a correlation coefficient on the basis of the pulse-compressed weather signal, and calculating a weather variable on the basis of the correlation coefficient; an operation control unit for controlling the operation processing unit, receiving the weather variable calculated by the operation processing unit, and converting same to a raw weather variable; and a display analysis unit for receiving the raw weather variable from the operation control unit, storing same, and displaying a product received in real time according to the raw weather variable.

### TECHNICAL FIELD

The present invention relates to a weather information signal processing module, and more particularly, to a weather information signal processing module that calculates a weather variable from a weather signal and displays the calculated weather variable.

### BACKGROUND ART

A weather observation apparatus receives weather observation data from a weather radar or an antenna, properly signal-processes the received data, thereby displaying real time observation data or generating a weather product.

In order to precisely check or forecast weather, a capability for properly processing weather data is required. However, when a current signal processing technology is used, a burden occurs due to a high required amount of calculation, and resolution is lowered.

### DETAILED DESCRIPTION OF THE INVENTION

### Technical Problem

The present invention provides a weather information signal processing module in which pulse compression processing is used to implement high resolution.

### Technical Solution

According to an aspect of the present invention, there is provided a weather information signal processing module including: a operation processing unit that pulse-compresses a weather signal received from the outside, calculates a correlation coefficient based on the pulse-compressed weather signal, and calculates a weather variable based on the correlation coefficient; an operation control unit that controls the operation processing unit, receives the weather variable calculated by the operation processing unit, and converts the weather variable to a raw weather variable; and a display analysis unit that receives the raw weather variable from the operation control unit, stores the raw weather variable, and displays a product received in real time according to the raw weather variable.

The operation processing unit may receive status information of an antenna or a transmission/receiving unit from the outside and may transmit the status information to the operation control unit, and the operation control unit may transmit the received status information to the display analysis unit.

The operation processing unit may include: a pulse compression unit that pulse-compresses the received weather signal; a correlation coefficient calculation unit that calculates a correlation coefficient based on the pulse-compressed weather signal; and a weather variable calculation unit that calculates a weather variable based on the calculated correlation coefficient.

The pulse compression unit may include: a format conversion unit that converts a horizontal polarized wave in-phase/quadrature-phase (I/Q) signal and a vertical polarized wave I/Q signal that are received weather signals, into a format of floating decimal point data; a linear frequency modulation (LFM) signal-applying unit that applies a reference LFM signal; a window application unit that applies window functions to the horizontal polarized wave I/Q signal and the vertical polarized wave I/Q signal and the reference LFM signal that are converted by the format conversion unit; a fast fourier transform (FFT) performance unit that performs FFT on the signals to which the window functions are applied; a convolution unit that performs convolution on the signals on which FFT is performed by the FFT performance unit; and an inverse FFT (IFFT) performance unit that generates a compressed horizontal polarized wave I/Q signal and a compressed vertical polarized wave I/Q signal by performing IFFT on the convoluted signals.

The correlation coefficient calculation unit may include: a mode selection unit that selects a time domain mode or a frequency domain mode; a time domain mode unit that calculates a single polarized wave correlation coefficient and a cross-polarized wave correlation coefficient by performing time domain clutter filtering on the compressed I/Q signal; and a frequency domain mode unit that calculates a single polarized wave correlation coefficient by performing frequency domain clutter filtering on the compressed I/Q signal.

The weather variable calculation unit may include: a threshold variable calculation unit that calculates a threshold variable based on the calculated correlation coefficient; a weather variable calculation unit that calculates a weather variable based on the calculated correlation coefficient; a threshold processing unit that removes a weather variable less than a threshold value and causes a weather variable that exceeds the threshold value to pass, based on the threshold variable and the weather variable; and a speckle removing unit that removes speckles from the weather variable that is threshold-processed by the threshold processing unit.

The weather variable calculation unit may further include a distance averaging unit that averages a distance of the calculated correlation coefficient.

The operation control unit may include: a controller including a transmission/receiving controller that generates a control instruction of a transmission/receiving unit that can make communication with the operation processing unit, an antenna controller that generates a control instruction of an antenna that can make communication with the transmission/receiving unit, an observation information unit that sets an observation mode according to the weather variable received from the operation processing unit, a filtering unit that determines a clutter filtering mode in the operation processing unit, a real time display unit that displays observation information in real time, and a radar byte information unit that collects and displays byte information of a radar; an operation unit including a scheduler unit that operates and manages an observation schedule, a scan configuration unit that sets an altitude angle, velocity of the antenna, an observation radius and a moment, and a product configuration unit that sets operation and management of a product; and a management unit including a calibration unit that controls calibration using a radar system parameter, an Ascope unit that processes and displays Ascope information, a remote controller that remote controls the radar, a configuration setting unit that sets and changes a system parameter, an archival unit that receives the weather variable from the operation processing unit and stores the weather variable as the raw weather variable, and a menu unit that specifies a file, a color table, and utility.

The display analysis unit may include: a display unit including a real time volume display unit that displays a map, a layer, a color table, and observation information in real time, a product display unit that displays each product from a file in which the product has been already stored, and a byte display unit including a geographic information system (GIS) map unit that configures a GIS-based map; an analysis unit including a product generation unit that generates and reproduces a new product, a product analysis unit that analyzes dual and single polarized wave products, and a gauge unit that makes a database of data of automatic weather system (AWS) and real time data transmission data from the outside; a quality control unit including a QC processing unit that performs quality control according to an altitude angle by applying a quality control algorithm to the product file, a QC display unit that compares images of quality control with each other, analyzes the images, and outputs an analysis image, an attenuation correction unit that displays an image obtained by applying an attenuation correction algorithm to the product file, and a bright band correction unit that displays an image obtained by applying a bright band correction algorithm to the product file; and a management unit including a Z-calibration unit that performs Z-calibration by applying a system parameter according to a unit and a ZDR-calibration unit that performs ZDR-calibration according to vertical directional observation by applying the system parameter.

The operation processing unit can make communication with the transmission/receiving unit through optical communication, and each of the operation processing unit and the operation control unit and the operation control unit and the display analysis unit can make communication with each other through Ethernet communication.

### Effects of the Invention

According to the present invention, a pulse compression processing operation is adopted in a weather signal processing operation so that high resolution can be implemented, and a window function is applied to pulse compression so that a problem of the occurrence of side lobes can be solved.

### DESCRIPTION OF THE DRAWINGS

FIG. 1 is a block diagram of a weather information signal processing module according to an embodiment of the present invention;

FIG. 2 is a block diagram of an operation processing unit according to an embodiment of the present invention;

FIG. 3 is a block diagram of a signal processing unit of FIG. 2 according to an embodiment of the present invention;

FIG. 4 is a block diagram of a pulse compression unit of FIG. 3 according to an embodiment of the present invention;

FIG. 5 is a block diagram of a correlation coefficient calculation unit of FIG. 3 according to an embodiment of the present invention;

FIG. 6 is a view of a structure of an infinite impulse response (IIR) time domain clutter filter according to an embodiment of the present invention;

FIG. 7 is a block diagram of a weather variable calculation unit according to an embodiment of the present invention;

FIG. 8 is a block diagram of an operation control unit according to an embodiment of the present invention;

FIG. 9 is a detailed block diagram of a controller of FIG. 8;

FIG. 10 is a detailed block diagram of an operation unit of FIG. 8;

FIG. 11 is a detailed block diagram of a management unit of FIG. 8;

FIG. 12 is a block diagram of a display analysis unit according to an embodiment of the present invention;

FIG. 13 is a detailed block diagram of a display unit of FIG. 12;

FIG. 14 is a detailed block diagram of an analysis unit of FIG. 12;

FIG. 15 is a detailed block diagram of a quality control unit of FIG. 12; and

FIG. 16 is a detailed block diagram of a management unit of FIG. 12.

### MODE OF THE INVENTION

An exemplary embodiment of the present invention will be described in detail with reference to the attached drawings.

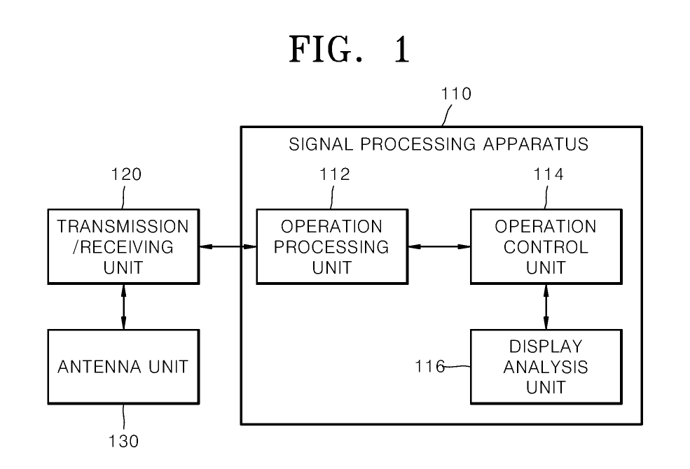

FIG. 1 is a block diagram of a weather information signal processing module according to an embodiment of the present invention.

Referring to FIG. 1, a weather information signal processing module (hereinafter, referred to as a ‘signal processing apparatus 110’) includes an operation processing unit 112, an operation control unit 114, and a display analysis unit 116. The operation processing unit 112 and the operation control unit 114 may make bidirectional communication with each other via Ethernet, and the operation control unit 114 and the display analysis unit 116 may make bidirectional communication with each other via Ethernet. A transmission/receiving unit 120 is connected to an antenna unit 130 and may make bidirectional communication with the operation processing unit 112 through light.

The operation processing unit 112 pulse-compresses a weather signal horizontal polarized wave in-phase/quadrature-phase (I/Q) signal and a weather signal vertical polarized wave I/Q signal that are received from the transmission/receiving unit 120 and then, calculates a correlation coefficient, calculates a weather variable based on the correlation coefficient, and transmits the calculated weather variable to the operation control unit 114. Also, the operation processing unit 112 receives a status checking/fault signal of the transmission/receiving unit 120/antenna unit 130 and transmits the received status checking/fault signal to the operation control unit 114. The operation processing unit 114 receives a control instruction signal of the transmission/receiving unit 120/antenna unit 130 from the operation control unit 114 and transmits the control instruction signal to the transmission/receiving unit 120/antenna unit 130.

The operation control unit 114 performs a function of controlling/operating a radar/antenna unit, writing/operating an observation schedule, monitoring a radar system, displaying real time observation, and converting a raw weather variable. The operation control unit 114 transmits the generated raw weather variable and the status checking/trouble signal of the transmission/receiving unit 120/antenna unit 130 received from the operation processing unit 112 to the display analysis unit 116.

The display analysis unit 116 receives and stores the raw weather variable and displays a product received in real time according to the raw weather variable.

The operation processing unit 112, the operation control unit 114, and the display analysis unit 116 will be described in detail below.

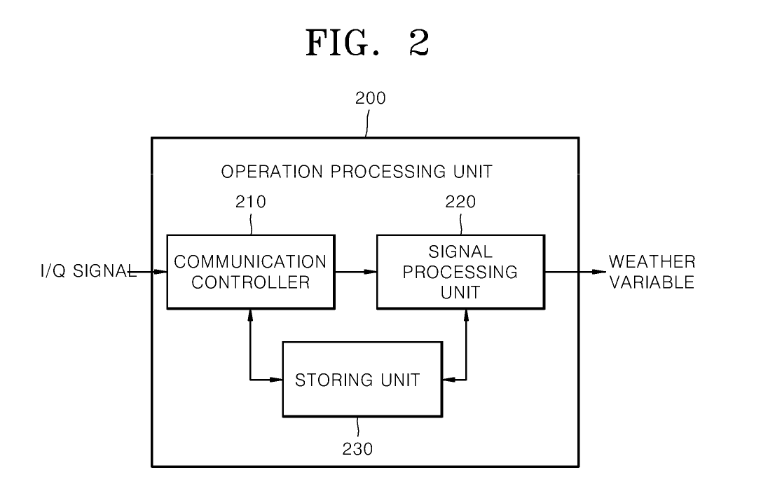

FIG. 2 is a block diagram of an operation processing unit according to an embodiment of the present invention.

Referring to FIG. 2, an operation processing unit 200 includes a communication controller 210, a signal processing unit 220, and a storing unit 230. The communication controller 210 receives a horizontal polarized wave I/Q signal and a vertical polarized wave I/Q signal from the transmission/receiving unit 120 through light and transmits the horizontal polarized wave I/Q signal and the vertical polarized wave I/Q signal to the signal processing unit 220 through a peripheral component interconnect (PCI). The communication controller 210 has an optical communication function based on a field programmable gate array (FPGA). The signal processing unit 220 generates a weather variable based on the horizontal polarized wave I/Q signal and the vertical polarized wave I/Q signal received from the communication controller 210 and transmits the weather variable to the operation control unit 114. The signal processing unit 220 will be described in detail below. The storing unit 230 stores temporary data processed by the signal processing unit 220. The storing unit 230 may be implemented with a solid-state drive (SSD). Also, the storing unit 230 is an element that may be omitted in consideration of a burden of a load.

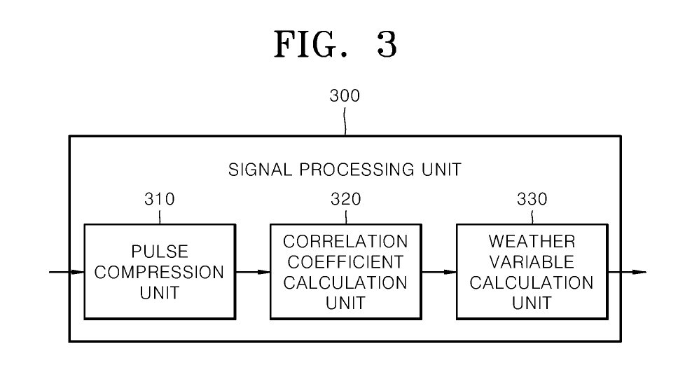

FIG. 3 is a block diagram of a signal processing unit of FIG. 2 according to an embodiment of the present invention.

Referring to FIG. 3, a signal processing unit 300 includes a pulse compression unit 310 that receives a horizontal/vertical (H/V) polarized wave I/Q signal including fixed decimal point data of 20 bits from a communication controller through a PCI and converts the received H/V polarized wave I/Q signal into the format of a floating decimal point and pulse-compresses the converted H/V polarized wave I/Q signal, a correlation coefficient calculation unit 320 that calculates a correlation coefficient from the compressed H/V polarized wave I/Q signal, and a weather variable calculation unit 330 that calculates a weather variable from the correlation coefficient. The signal processing unit 300 outputs the calculated weather variable to the operation control unit 114. Although not shown, the signal processing unit 300 may further include a communication unit, such as a PCI that may communicate with the communication controller in the operation processing unit, and a communication unit, such as Ethernet that may communicate with the operation control unit or a display analysis unit. Elements of the signal processing unit 300 will be described in detail below.

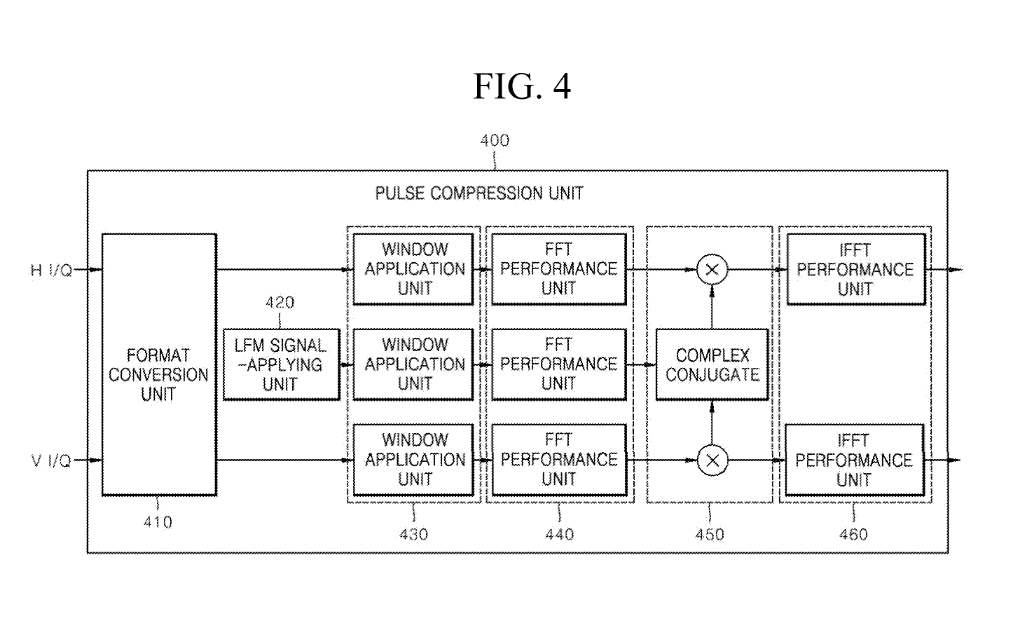

FIG. 4 is a block diagram of a pulse compression unit of FIG. 3 according to an embodiment of the present invention.

Referring to FIG. 4, a pulse compression unit 400 includes a format conversion unit 410, a linear frequency modulation (LFM) signal-applying unit 420, a window application unit 430, a fast fourier transform (FFT) performance unit 440, a convolution unit 450, and an inverse FFT (IFFT) performance unit 460.

The pulse compression unit 400 receives the horizontal/vertical (H/V) polarized wave I/Q signal including fixed decimal point data of 20 bits, and the format conversion unit 410 converts the received horizontal/vertical (H/V) polarized wave I/Q signal including fixed decimal point data of 20 bits into the format of a floating decimal point of 32 bits.

After that, the pulse compression unit 400 performs pulse compression. A pulse compression method includes a time domain method and a frequency domain method. The time domain method is a procedure for convoluting a received LFM (or chirp) signal and a reference LFM signal. In this case, since the amount of calculation is required in units of N² (N is the number of samples), when the number of samples is increased, the amount of calculation is exponentially increased. Thus, the frequency domain method using FFT is generally applied to pulse compression. In this case, the frequency domain method is mathematically the same as the time domain method. However, the amount of calculation is required in units of N log N, and as the number of samples is increased, the amount of calculation is greatly decreased compared to the time domain method. However, since FFT is used, the number of samples should correspond to a multiplier of 2. FIG. 3 relates to a pulse compression method using the frequency domain method.

The LFM signal-applying unit 420 applies the reference LFM signal to the window application unit 430. The window application unit 430 applies window functions to the applied reference LFM signal, the horizontal polarized wave I/Q signal, and the vertical polarized wave I/Q signal. Examples of window functions include a hamming function, a blackman function, and a Kaiser function. The window functions are not limited. When no window function is applied before FFT is performed, a large number of side lobes is generated in the pulse-compressed signal. In this case, the window function is applied before FFT is performed, so that the number of side lobes is greatly reduced. However, main lobes may be widened so that a proper window function should be applied according to circumstances.

The FFT performance unit 440 performs FFT on the reference LFM signal, the horizontal polarized wave I/Q signal, and the vertical polarized wave I/Q signal to which the window functions are applied. The convolution unit 450 convolutes the LFM signal and the horizontal polarized wave I/Q signal on which FFT is performed, and convolutes the LFM signal and the vertical polarized wave I/Q signal on which FFT is performed. After that, the IFFT performance unit performs IFFT on the convoluted signal, generates a compressed horizontal polarized wave complex pulse and a compressed vertical polarized wave complex pulse and transmits the generated compressed horizontal polarized wave complex pulse and a compressed vertical polarized wave complex pulse to the correlation coefficient calculation unit.

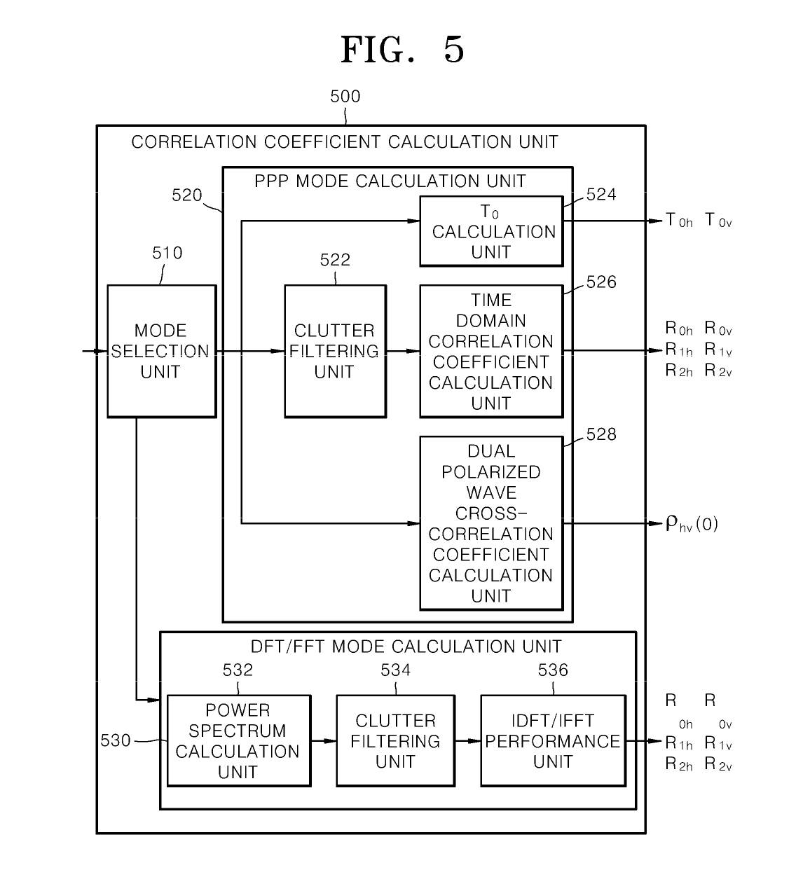

FIG. 5 is a block diagram of a correlation coefficient calculation unit of FIG. 3 according to an embodiment of the present invention.

Referring to FIG. 5, a correlation coefficient calculation unit 500 includes a mode selection unit 510, a pulse pair processing (PPP) mode calculation unit 520, and a discret fourier transform/fast fourier transform (DFT/FFT) mode calculation unit 530. The PPP mode calculation unit 520 includes a clutter filtering unit 522, a T₀ calculation unit 524, a time domain correlation coefficient calculation unit 526, and a dual polarized wave cross-correlation coefficient calculation unit 528. The DFT/FFT mode calculation unit 530 includes a power spectrum calculation unit 532, a clutter filtering unit 534, and an IDFT/IFFT performance unit 536.

The correlation coefficient calculation unit 500 receives the compressed horizontal polarized wave complex pulse and the compressed vertical polarized wave complex pulse, calculates a correlation coefficient thereof and performs clutter filtering. Clutter filtering is applied to calculation of R₀, R₁, and R₂ that are single polarized wave correlation coefficients so that R₀, R₁, and R₂ are calculated. A procedure of obtaining the single polarized wave correlation coefficients is classified into a PPP mode that is a time domain calculation method and a DFT/FFT mode that is a frequency domain calculation method. The FFT mode is applied to reduce the amount of calculation when the number of pulses is a multiplier of 2 in a DFT mode. Time domain clutter filtering is applied to clutter filtering in the PPP mode, and frequency domain clutter filtering is applied to clutter filtering in the DFT/FFT mode. Time domain clutter filtering has a small amount of calculation and may be applied regardless of an operation mode and the type of a weather variable. However, when a clutter and weather data overlap each other, the clutter and the weather data cannot be distinguished from each other so that the weather data is damaged. An adaptive filtering technique may be applied to frequency domain clutter filtering. Thus, when the clutter and the weather data overlap each other, damage of the weather data is minimized. However, frequency domain clutter filtering has a large amount of calculation and may be applied only when a distance between pulses is uniform. Thus, frequency domain clutter filtering is not applied to calculate a partial dual polarized wave weather variable. In these days, due to the development of hardware performance, there is no problem in performing the frequency domain clutter filtering. Thus, only frequency domain clutter filtering is applied to single polarized wave calculation, and time domain clutter filtering is used to calculate a dual polarized wave correlation coefficient or when the distance between pulses is not uniform.

The mode selection unit 510 determines whether to calculate the correlation coefficient in the PPP mode or to calculate the correlation coefficient in the DFT/FFT mode so as to calculate R₀, R₁, and R₂ that are single polarized wave correlation coefficients.

When the PPP mode calculation unit 520 is selected, in order to calculate R₀, R₁, and R₂, the clutter filtering unit 522 performs clutter filtering on the received horizontal/vertical polarized wave complex pulse. An infinite impulse response (IIR) time domain clutter filter is used in the clutter filtering unit 522 in the PPP mode. A −40 dB filter or −50 dB filter is used as the IIR time domain clutter filter according to a clutter removing capability. These are selectively applied according to a clutter width.

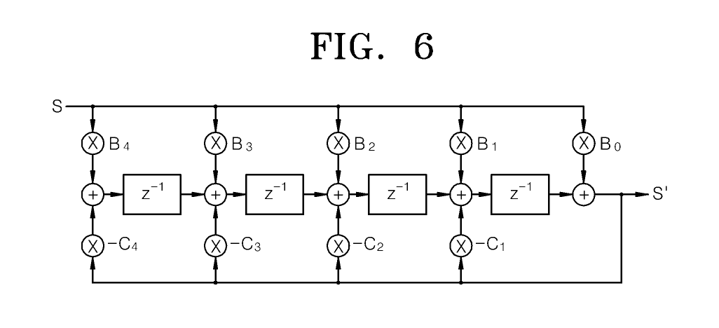

FIG. 6 is a view of a structure of an IIR time domain clutter filter according to an embodiment of the present invention.

Referring to FIG. 6, s is a received complex pulse, and s′ is a filtered complex pulse. Here, B₀ to B₄ and C₁ to C₄ are filter coefficients. An equation for obtaining s′ is as shown in the following Equation 1.

s′ₙ=B₀sₙ+B₁sₙ₋₁B₂sₙ₋₂+B₃sₙ₋₃+B₄sₙ₋₄−C₁s′ₙ₋₁+C₂s′ₙ₋₂+C₃s′ₙ₋₃+C₄s′ₙ₋₄

As known from characteristics of the IIR time domain clutter filter, the IIR time domain clutter filter suppresses all signals around zero-velocity to a predetermined size on an assumption that the velocity of a clutter is 0, so that a weather signal adjacent to the clutter is damaged.

The time domain correlation coefficient calculation unit 526 calculates R₀, R₁, and R₂ using the clutter-filtered horizontal/vertical polarized wave complex pulse. R₀ is a zero^{th} lag autocorrelation of the filtered complex pulse, and R₁ is a first lag autocorrelation of the filtered complex pulse, and R₂ is a second lag autocorrelation of the filtered complex pulse.

Calculation equations of R₀, R₁, and R₂ are as shown in the following Equations 2, 3, and 4.

$$\begin{matrix} {R}_{0} = \frac{1}{M} {\sum }_{n = 1}^{M} \text{?} {s}_{n}^{′} & [ Equation 2 ] \\ {R}_{1} = \frac{1}{M - 1} {\sum }_{n = 1}^{M - 1} \text{?} {s}_{n + 1}^{′} & [ Equation 3 ] \\ {R}_{2} = \frac{1}{M - 2} {\sum }_{n = 1}^{M - 2} \text{?} {s}_{n + 2}^{′} \\ \text{?} \text{indicates text missing or illegible when filed} & [ Equation 4 ]\end{matrix}$$

In the case of R₀, R₁, and R₂, R₀ₕ, R₁ₕ, and R₂ₕ related to horizontal polarized wave and R₀ᵥ, R₁ᵥ, and R₂ᵥ related to vertical polarized wave are calculated.

When the DFT/FFT mode calculation unit 530 is selected, the power spectrum calculation unit 532 calculates a power spectrum of each horizontal/vertical polarized wave in the frequency domain from the received complex pulse. A calculation equation for obtaining the power spectrum is as shown in the following Equation 5.

$$\begin{matrix} {S}_{k} = {\vert {DFT}_{k} \{ {w}_{m} {s}_{m} \} \vert}^{2} \text{?} \\ = {\vert {\sum }_{m = 0}^{M} {w}_{m} {s}_{m} {e}^{- j ( \frac{2 π}{M} ) mK} \vert}^{2}\end{matrix} \\ \text{?} \text{indicates text missing or illegible when filed} \qquad [ Equation 5 ]$$

Since fourier transform is used in the frequency domain, the window function may be used to calculate the power spectrum so as to reduce the number of side lobes. In Equation 5, w is a window function.

The clutter filtering unit 534 obtains a power spectrum of each polarized wave component and then frequency domain clutter filters the power spectrum. The clutter filtering unit 534 distinguishes a spectrum of a clutter portion from the frequency domain, removes data of the clutter portion around zero velocity and then estimates weather data of the removed portion using an adjacent value. A method of restoring a weather signal of the removed portion includes linear interpolation and a Gaussian model adaptive processing (GMAP) method.

The IDFT/IFFT performance unit 536 performs IDFT/IFFT on the filtered power spectrum of each polarized wave component. In this case, first three coefficients of an IDFT/IFFTed coefficient, i.e., zero^{th}, first, and second coefficients are R₀ₕ, R₀ᵥ, R₁ₕ, R₁ᵥ, R₂ₕ, and R₂ᵥ.

T₀ and a dual polarized wave cross-correlation coefficient ρₕᵥ are calculated in the PPP mode.

The T₀ calculation unit 524 calculates T₀ₕ and T₀ᵥ from the horizontal/vertical polarized wave complex pulse. T₀ is a zero^{th} lag autocorrelation of the unfiltered complex pulse, and T₀ₕ is horizontal polarized wave T₀, and T₀ᵥ is vertical polarized wave T₀. T₀ is calculated from each of horizontal polarized wave and vertical polarized wave, and a calculation equation thereof is as shown in the following Equation 6.

$${T}_{0} = \frac{1}{M} {\sum }_{n = 1}^{M} \text{?} {s}_{n} \\ \text{?} \text{indicates text missing or illegible when filed} \qquad [ Equation 6 ]$$

In Equation 6, M is the number of pulses, and s is a received complex pulse.

The dual polarized wave cross-correlation coefficient calculation unit 528 calculates the dual polarized wave cross-correlation coefficient ρₕᵥ from the received complex pulse. ρₕᵥ(0) is a zero^{th} lag cross-correlation coefficient of an unfiltered vertical polarized wave complex pulse and horizontal polarized wave complex pulse. A calculation equation of ρₕᵥ(0) is as shown in the following Equation 7.

$${ρ}_{hv} ( 0 ) = \frac{\sum {s}_{vv} \text{?}}{\sqrt{\sum {s}_{vv}^{2} \sum {s}_{hh}^{2}}} \\ \text{?} \text{indicates text missing or illegible when filed} \qquad [ Equation 7 ]$$

Clutter filtering is not basically performed on ρₕᵥ(0), but clutter filtering may be selectively performed on ρₕᵥ(0).

The correlation coefficient calculation unit 500 transmits the calculated correlation coefficients to a weather variable calculation unit.

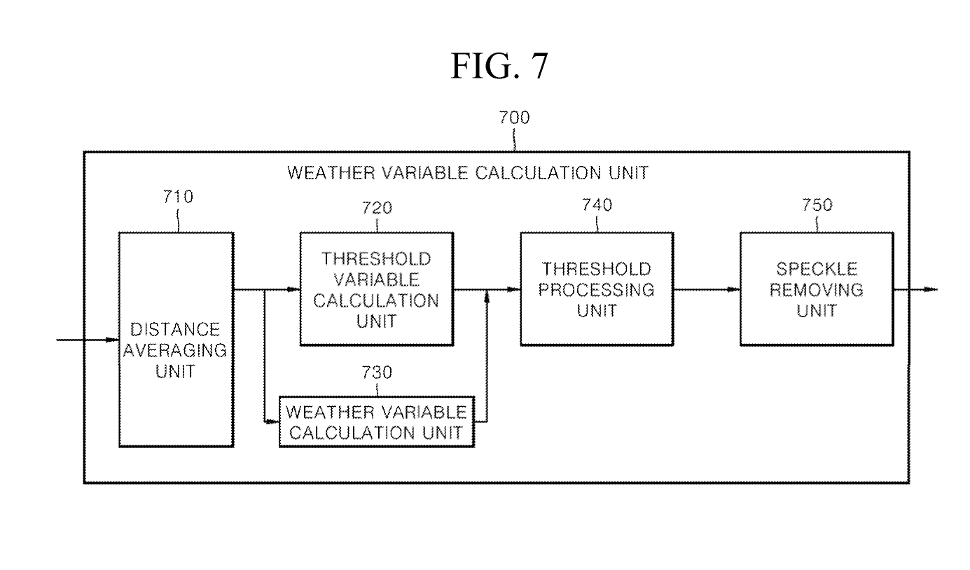

FIG. 7 is a block diagram of a weather variable calculation unit according to an embodiment of the present invention.

Referring to FIG. 7, a weather variable calculation unit 700 includes a distance averaging unit 710, a threshold variable calculation unit 720, a weather variable calculation unit 730, a threshold processing unit 740, and a speckle removing unit 750.

The distance averaging unit 710 actually averages a correlation coefficient that corresponds to n distances. Advantages of a distance averaging procedure include a reduction in the amount of calculation and suppressing noise and a local non-weather echo. However, since the n distances are averaged, distance resolution is lowered. The distance averaging procedure is a procedure that is selectively applied to a case where noise needs to be suppressed in a situation in which resolution is not significant. Thus, the distance averaging unit 710 is an element that is selectively applied.

The threshold variable calculation unit 720 calculates a threshold variable that is a variable for threshold processing. Types of the threshold variable include LOG, SQI, CCOR, and SIG. Equations for obtaining LOG, SQI, CCOR, and SIG are as shown in Equations 8 through 11.

$$\begin{matrix}LOG = 10 log [ \frac{{R}_{0}}{N} ] & [ Equation 8 ] \\ SQI = \frac{\vert {R}_{1} \vert}{{R}_{0}} & [ Equation 9 ] \\ CCOR = 10 log \frac{\vert {R}_{1} \vert {exp}^{\frac{{π}^{2} {w}^{2}}{2}}}{{T}_{0} - {R}_{0} + \vert {R}_{1} \vert {exp}^{\frac{{π}^{2} {w}^{2}}{2}}} & [ Equation 10 ] \\ SIG = 10 log [ \frac{2 π S}{{R}_{0} - 2 π S} ] & [ Equation 11 ]\end{matrix}$$

In Equation 8, N is noise power.

The weather variable calculation unit 730 calculates Z, V, W, and ZDR that are weather variables for each polarized wave using the received correlation coefficient and calculates pHV, φDP, and KDP that are dual polarized wave cross-correlation weather variables.

Equations for obtaining Z, V, W, ZDR, pHV, and φDP that are weather variables are as shown in the following Equations 12 through 17.

$$\begin{matrix}dBZ = 10 log [ \frac{{T}_{0} - N}{N} ] + {dBZ}_{0} + 20 log r + ar + CCOR & [ Equation 12 ] \\ V = \frac{λ}{4 π \frac{1}{PRF}} arg \{ {R}_{0} \} & [ Equation 13 ] \\ W = \frac{\sqrt{\frac{2}{3} ln [ \frac{\vert {R}_{1} \vert}{\vert {R}_{2} \vert} ]}}{π} & [ Equation 14 ] \\ ZDR = dBZh - dBZv + {ZDR}_{offset} & [ Equation 15 ] \\ ρ HV = \vert {ρ}_{hv} ( 0 ) \vert & [ Equation 16 ] \\ φ DP = arg [ {ρ}_{hv} ( 0 ) ] & [ Equation 17 ]\end{matrix}$$

In Equations 12 through 17, a is atmospheric attenuation, and r is a distance, and N is noise power. Also, values dBZ₀ and ZDR_{offset} are received from the operation control unit.

A specific difference phase (KDP) among the weather variables is not directly calculated from the correlation coefficient but is secondarily calculated. The KDP is calculated using a variation amount (differential value) over time of φDP, as shown in Equation 18.

$$KDP = \frac{φ DP ( {r}_{2} ) - φ DP ( {r}_{1} )}{2 ( {r}_{2} - {r}_{1} )} \qquad [ Equation 18 ]$$

Velocity V among the weather variables may be velocity unfolding processed. Velocity unfolding is a procedure of increasing the range of observation velocity by increasing the range of unambiguous velocity using dual PRF.

The threshold processing unit 740 removes weather variables less than a threshold value, i.e., causes only weather variables that exceed the threshold value to pass, so as to improve quality of the calculated weather variables.

Table 1 shows applied threshold variables caused by weather variables.

TABLE 1

| Weather variables | Applied threshold variables (AND/OR) |
|---|---|
| dBZ | LOG( \| SIG), CCOR |
| V | SQI, CCOR |
| W | SQI, CCOR, SIG |
| ZDR | LOG |
| Dual Pol | SQI, ρHV |

Table 2 shows an example of the range of a threshold value.

TABLE 2

| Threshold values | Ranges | |
|---|---|---|
| LOGₜₕᵣₑₛₕ | 0 to 40 | dB |
| SQIₜₕᵣₑₛₕ | 0 to 1 | |
| CCORₜₕᵣₑₛₕ | 0 to −100 | dB |
| SIGₜₕᵣₑₛₕ | 0 to 100 | dB |

| | |
|---|---|
| ρHVₜₕᵣₑₛₕ | 0 to 1 |

The applied threshold variables and the threshold value range are not limited to the above tables and are determined after signal quality analysis is performed using an external display analysis unit.

The speckle removing unit 750 interpolates or removes isolated data after threshold processing is performed, based on peripheral data so as to manage the quality of the weather variables. The speckle removing unit 750 examines n effectiveness of a neighbor value of isolated variables. If n or more peripheral data are effective, the data removed by the threshold processing is interpolated as peripheral effective values. If n or less peripheral data are effective, the data passed by the threshold processing is removed. The weather variables are finally calculated after speckles are removed.

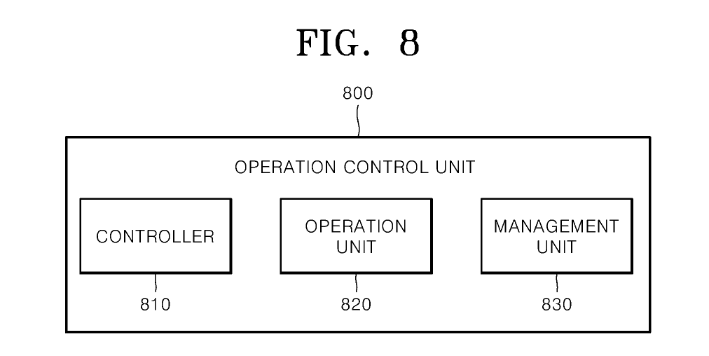

FIG. 8 is a block diagram of an operation control unit according to an embodiment of the present invention.

Referring to FIG. 8, an operation control unit 800 includes a controller 810, an operation unit 820, and a management unit 830. Each of these elements will be described in detail below.

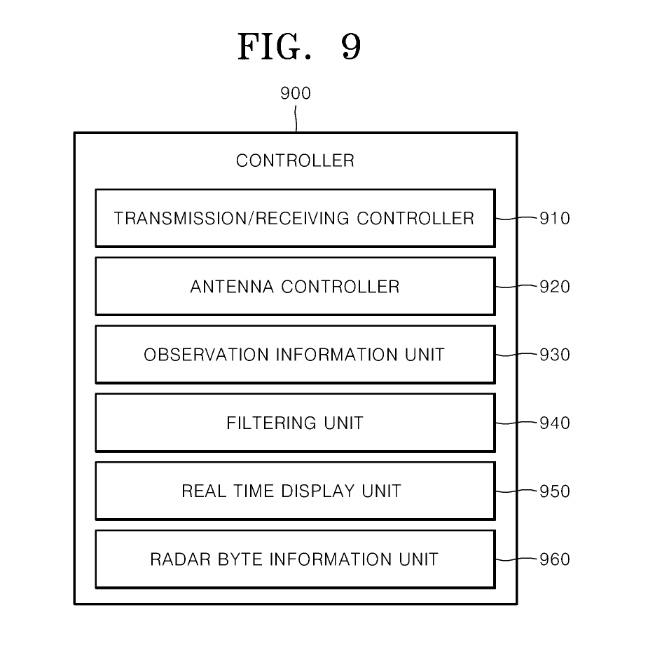

FIG. 9 is a detailed block diagram of a controller of FIG. 8.

Referring to FIG. 9, a controller 900 includes a transmission/receiving controller 910, an antenna controller 920, an observation information unit 930, a filtering unit 940, a real time display unit 950, and a radar byte information unit 960.

The transmission/receiving controller 910 generates a control instruction regarding a transmission/receiving unit, to control power on/off and radiation of the transmission/receiving unit. The generated control instruction is transmitted to the transmission/receiving unit via the operation processing unit.

The antenna controller 920 generates an antenna control instruction, such as scan control of an antenna and setting an azimuth angle/altitude angle, setting velocity of the antenna, and setting a polarized wave. The generated control instruction is transmitted to the antenna via the operation processing unit.

The observation information unit 930 receives and processes the weather variable and sets an observation mode, such as PPI, RHI, Sector, and Point that are generated according to moments Z, V, W, ZDR, pHV, and φDP.

The filtering unit 940 generates a control instruction to select a PPP mode or a DFT/FFT mode in the correlation coefficient calculation unit of the signal processing unit of the operation processing unit. The generated control instruction is transmitted to the operation processing unit.

The real time display unit 950 displays a geographic information system (GIS) map, a layer, a color table, and observation information (moment), in units of ray.

The radar byte information unit 960 collects byte information of the radar and displays the byte information of the radar.

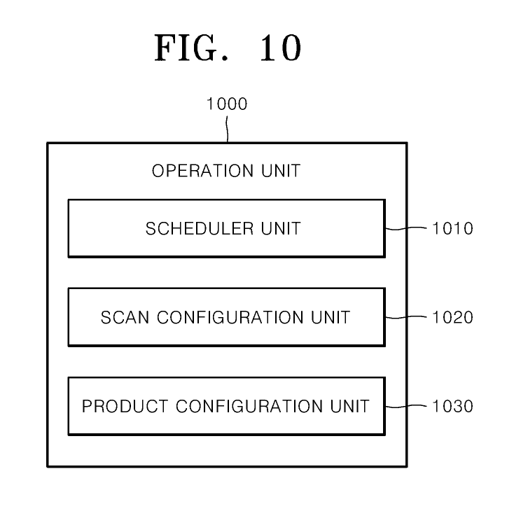

FIG. 10 is a detailed block diagram of an operation unit of FIG. 8.

Referring to FIG. 10, an operation unit 1000 includes a scheduler unit 1010, a scan configuration unit 1050, and a product configuration unit 1060.

The scheduler unit 1010 sets an observation operation schedule according to on/off and an observation strategy of an observation scheduler.

The scan configuration unit 1020 sets an altitude angle, antenna velocity, an observation radius, and a moment.

The product configuration unit 1030 sets PPI tilting, a CAPPI altitude angle, and a Z-R interaction formula.

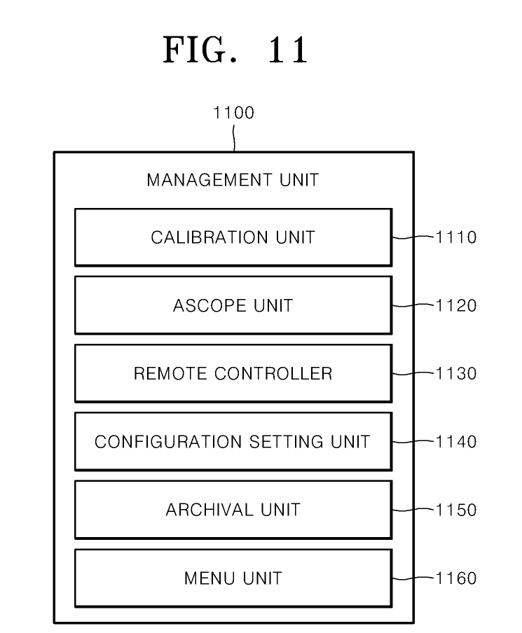

FIG. 11 is a detailed block diagram of a management unit of FIG. 8.

Referring to FIG. 11, a management unit 1100 includes a calibration unit 1110, an Ascope unit 1120, a remote controller 1130, a configuration setting unit 1140, an archival unit 1150, and a menu unit 1160.

The calibration unit 1110 controls and processes calibration, and in detail, sets a radar system parameter and a system loss.

The Ascope unit 1120 processes and displays Ascope information, and in detail, displays a weather variable and a cross-coefficient according to a polarized wave.

The remote controller 1130 that is a radar remote control interface sets remote site information and a network and sets transmission data.

The configuration setting unit 1140 sets and changes the system parameter, and in detail, sets a system, a digital signal processor (DSP), a moment, and a product environment.

The archival unit 1150 stores, reproduces or outputs a signal, a volume, and a product. In particular, the archival unit 150 receives the weather variable from the operation processing unit, stores the weather variable as a raw weather variable, and transmits the raw weather variable to a display analysis unit.

The menu unit 1160 specifies a file, a color table, and utility.

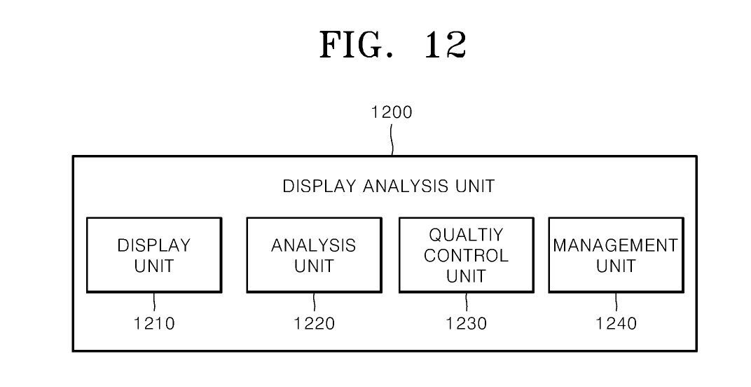

FIG. 12 is a block diagram of a display analysis unit according to an embodiment of the present invention.

Referring to FIG. 12, a display analysis unit 1200 includes a display unit 1210, an analysis unit 1220, a quality control unit 1230, and a management unit 1240. Each of these elements will be described in detail below.

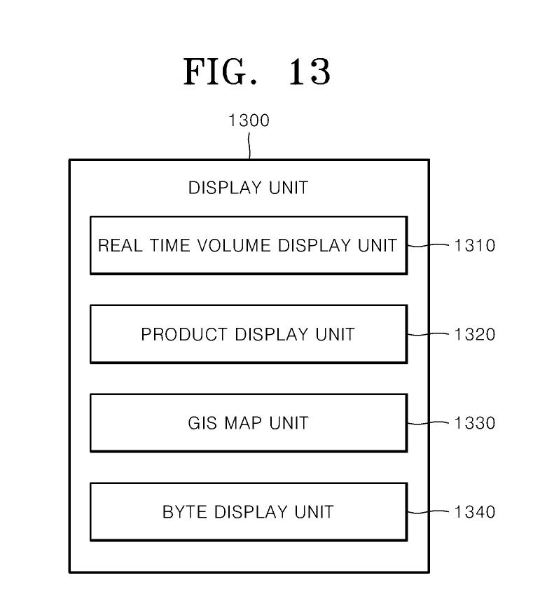

FIG. 13 is a detailed block diagram of a display unit of FIG. 12.

Referring to FIG. 13, a display unit 1300 includes a real time volume display unit 1310, a product display unit 1320, a GIS map unit 1330, and a byte display unit 1340.

The real time volume display unit 1310 displays a GIS map, a layer, a color table, and observation information (moment) in units of ray from a file in which the product has been received, in real time.

The product display unit 1320 displays each product from a file in which a past product has been stored, and displays wind field interlocking.

The GIS map unit 1330 configures a map based on the GIS.

The byte display unit 1340 displays byte information according to each unit.

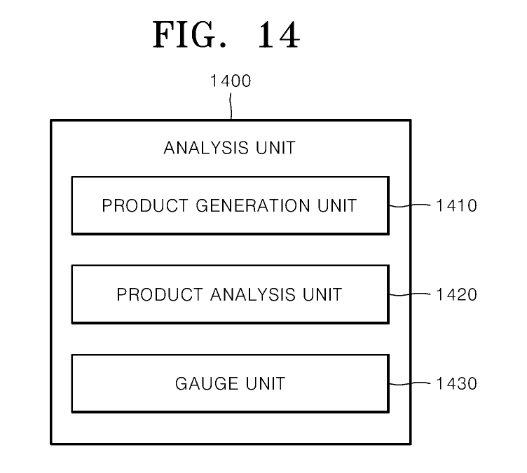

FIG. 14 is a detailed block diagram of an analysis unit of FIG. 12.

Referring to FIG. 14, an analysis unit 1400 includes a product generation unit 1410, a product analysis unit 1420, and a gauge unit 1430.

The product generation unit 1410 generates and reproduces a new product from the file in which the product has been stored, and performs mutual conversion of UF and NetCDF.

The product analysis unit 1420 analyzes dual and single polarized wave products from the product file and a ZR variable.

The gauge unit 1430 makes a database of data of automatic weather system (AWS) of Meteorological Administration and data of TM (real time data transmission) data of Ministry of Land, Transport and Maritime Affairs.

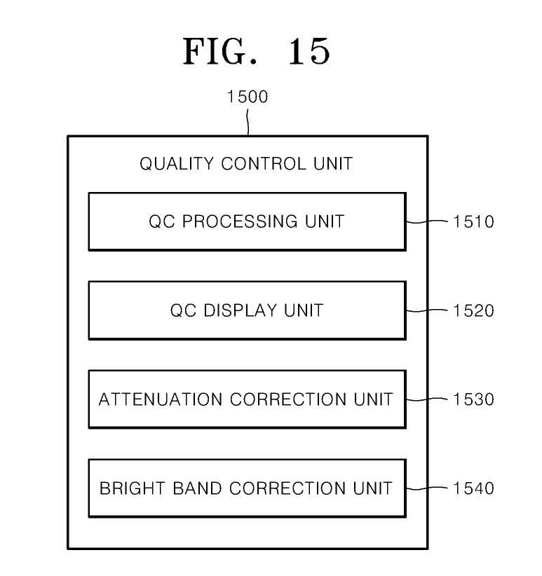

FIG. 15 is a detailed block diagram of a quality control unit of FIG. 12.

Referring to FIG. 15, a quality control unit 1500 includes a QC processing unit 1510, a QC display unit 1520, an attenuation correction unit 1530, and a bright band correction unit 1540.

The QC processing unit 1510 performs quality control according to an altitude angle by applying a quality control algorithm to the product file.

The QC display unit 1520 compares an image before quality control is performed, with an image after quality control is performed, analyzes the images, and outputs an analysis image.

The attenuation correction unit 1530 displays an image obtained by applying a rainfall attenuation correction algorithm to the product file.

The bright band correction unit 1540 displays an image obtained by applying a bright band correction algorithm to the product file.

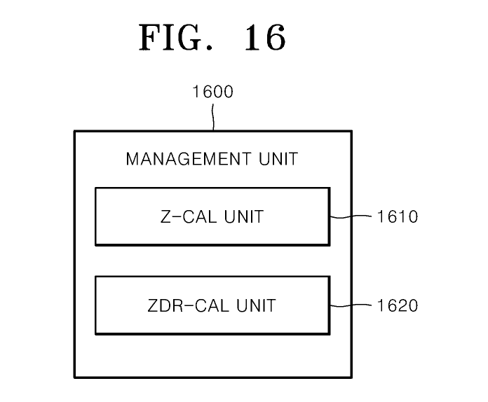

FIG. 16 is a detailed block diagram of a management unit of FIG. 12.

Referring to FIG. 16, a management unit 1600 includes a Z-cal unit 1610 and a ZDR-Cal unit 1620.

The Z-cal unit 1610 performs Z-calibration by applying a system parameter according to a system and outputs a dBZ₀ value.

The ZDR-Cal unit 1620 performs ZDR-calibration according to vertical directional observation by applying a system parameter and outputs a ZDR offset value.

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

According to the present invention, a weather information signal processing module in which pulse compression operation is adopted in a weather signal processing operation so that high resolution can be implemented, and a window function is applied to pulse compression so that a problem of the occurrence of side lobes can be solved, can be configured.

1. A weather information signal processing module comprising:
an operation processing unit that pulse-compresses a weather signal received from the outside, calculates a correlation coefficient based on the pulse-compressed weather signal, and calculates a weather variable based on the correlation coefficient;
an operation control unit that controls the operation processing unit, receives the weather variable calculated by the operation processing unit, and converts the weather variable to a raw weather variable; and
a display analysis unit that receives the raw weather variable from the operation control unit, stores the raw weather variable, and displays a product received in real time according to the raw weather variable.

2. The weather information signal processing module of claim 1, wherein the operation processing unit receives status information of an antenna or a transmission/receiving unit from the outside and transmits the status information to the operation control unit, and
the operation control unit transmits the received status information to the display analysis unit.

3. The weather information signal processing module of claim 1, wherein the operation processing unit comprises:
a pulse compression unit that pulse-compresses the received weather signal;
a correlation coefficient calculation unit that calculates a correlation coefficient based on the pulse-compressed weather signal; and
a weather variable calculation unit that calculates a weather variable based on the calculated correlation coefficient.

4. The weather information signal processing module of claim 3, wherein the pulse compression unit comprises:
a format conversion unit that converts a horizontal polarized wave in-phase/quadrature-phase (I/Q) signal and a vertical polarized wave I/Q signal that are received weather signals, into a format of floating decimal point data;
a linear frequency modulation (LFM) signal-applying unit that applies a reference LFM signal;
a window application unit that applies window functions to the horizontal polarized wave I/Q signal and the vertical polarized wave I/Q signal and the reference LFM signal that are converted by the format conversion unit;
a fast fourier transform (FFT) performance unit that performs FFT on the signals to which the window functions are applied;
a convolution unit that performs convolution on the signals on which FFT is performed by the FFT performance unit; and
an inverse FFT (IFFT) performance unit that generates a compressed horizontal polarized wave I/Q signal and a compressed vertical polarized wave I/Q signal by performing IFFT on the convoluted signals.

5. The weather information signal processing module of claim 4, wherein the correlation coefficient calculation unit comprises:
a mode selection unit that selects a time domain mode or a frequency domain mode;
a time domain mode unit that calculates a single polarized wave correlation coefficient and a cross-polarized wave correlation coefficient by performing time domain clutter filtering on the compressed I/Q signal; and
a frequency domain mode unit that calculates a single polarized wave correlation coefficient by performing frequency domain clutter filtering on the compressed I/Q signal.

6. The weather information signal processing module of claim 4, wherein the weather variable calculation unit comprises:
a threshold variable calculation unit that calculates a threshold variable based on the calculated correlation coefficient;
a weather variable calculation unit that calculates a weather variable based on the calculated correlation coefficient;
a threshold processing unit that removes a weather variable less than a threshold value and causes a weather variable that exceeds the threshold value to pass, based on the threshold variable and the weather variable; and
a speckle removing unit that removes speckles from the weather variable that is threshold-processed by the threshold processing unit.

7. The weather information signal processing module of claim 6, wherein the weather variable calculation unit further comprises a distance averaging unit that averages a distance of the calculated correlation coefficient.

8. The weather information signal processing module of claim 1, wherein the operation control unit comprises:
a controller comprising a transmission/receiving controller that generates a control instruction of a transmission/receiving unit that can make communication with the operation processing unit, an antenna controller that generates a control instruction of an antenna that can make communication with the transmission/receiving unit, an observation information unit that sets an observation mode according to the weather variable received from the operation processing unit, a filtering unit that determines a clutter filtering mode in the operation processing unit, a real time display unit that displays observation information in real time, and a radar byte information unit that collects and displays byte information of a radar;
an operation unit comprising a scheduler unit that operates and manages an observation schedule, a scan configuration unit that sets an altitude angle, velocity of the antenna, an observation radius and a moment, and a product configuration unit that sets operation and management of a product; and
a management unit comprising a calibration unit that controls calibration using a radar system parameter, an Ascope unit that processes and displays Ascope information, a remote controller that remote controls the radar, a configuration setting unit that sets and changes a system parameter, an archival unit that receives the weather variable from the operation processing unit and stores the weather variable as the raw weather variable, and a menu unit that specifies a file, a color table, and utility.

9. The weather information signal processing module of claim 1, wherein the display analysis unit comprises:
a display unit comprising a real time volume display unit that displays a map, a layer, a color table, and observation information in real time, a product display unit that displays each product from a file in which the product has been already stored, and a byte display unit comprising a geographic information system (GIS) map unit that configures a GIS-based map;
an analysis unit comprising a product generation unit that generates and reproduces a new product, a product analysis unit that analyzes dual and single polarized wave products, and a gauge unit that makes a database of data of automatic weather system (AWS) and real time data transmission data from the outside;
a quality control unit comprising a QC processing unit that performs quality control according to an altitude angle by applying a quality control algorithm to the product file, a QC display unit that compares images of quality control with each other, analyzes the images, and outputs an analysis image, an attenuation correction unit that displays an image obtained by applying an attenuation correction algorithm to the product file, and a bright band correction unit that displays an image obtained by applying a bright band correction algorithm to the product file; and
a management unit comprising a Z-calibration unit that performs Z-calibration by applying a system parameter according to a unit and a ZDR-calibration unit that performs ZDR-calibration according to vertical directional observation by applying the system parameter.

10. The weather information signal processing module of claim 2, wherein the operation processing unit is capable of making communication with the transmission/receiving unit through optical communication, and each of the operation processing unit and the operation control unit and the operation control unit and the display analysis unit is capable of making communication with each other through Ethernet communication.
